(19) United States
(12) Patent Application Publication
(10) Pub. No.: US 2016/0210648 A1
(43) Pub. Date: Jul. 21, 2016

(54) METHODS AND SYSTEMS FOR DYNAMIC PRICING AND PERFORMING OTHER PROCESSES ASSOCIATED WITH RECYCLING MOBILE PHONES AND OTHER ELECTRONIC DEVICES

(71) Applicant: ecoATM, Inc., San Diego, CA (US)

(72) Inventor: Vanessa Cirannek, San Diego, CA (US)

(21) Appl. No.: 14/598,469

(22) Filed: Jan. 16, 2015

(51) Int. Cl. G06Q 30/02; G06Q 10/00

(52) U.S. Cl. CPC G06Q 30/0206; G06Q 10/30

(57) ABSTRACT

The present disclosure describes various embodiments of methods and systems for dynamically developing pricing and performing other processes associated with purchasing and recycling mobile phones, other consumer electronic devices, and/or other goods and services. In some embodiments, the methods and systems disclosed herein can be employed by a user-operated kiosk to determine a price to offer a user for a mobile phone or other electronic device to maximize or at least increase total margins. In some embodiments, the price can be dynamically adjusted to respond to varying market conditions.

### TECHNICAL FIELD

The present disclosure is directed generally to methods and systems for recycling mobile phones and other consumer electronic devices and, more particularly, to methods and systems associated with pricing such devices.

### BACKGROUND

Consumer electronic devices, such as mobile phones, laptop computers, notebooks, tablets, MP3 players, etc., are ubiquitous. Currently there are over 6 billion mobile devices in use in the world; and this number is growing rapidly as more than 1.8 billion mobile phones were sold in 2013 alone. By 2017 it is expected that there will be more mobile devices in use than people on the planet. In addition to mobile phones, over 300 million desk-based and notebook computers shipped in 2013, and for the first time the number of tablet computers shipped exceeded laptops. Part of the reason for the rapid growth in the number of mobile phones and other electronic devices is the rapid pace at which these devices evolve, and the increased usage of such devices in developing countries.

As a result of the rapid pace of development, a relatively high percentage of electronic devices are replaced every year as consumers continually upgrade their mobile phones and other electronic devices to obtain the latest features or a better operating plan. According to the U.S. Environmental Protection Agency, consumers in the United States alone dispose of over 370 million mobile phones, PDAs, tablets, and other electronic devices every year. Millions of other outdated or broken mobile phones and other electronic devices are simply tossed into junk drawers or otherwise kept until a suitable disposal solution arises.

Although many electronic device retailers and cell carrier stores now offer mobile phone trade-in or buyback programs, many old mobile phones still end up in landfills or are improperly disassembled and disposed of in developing countries. Mobile phones and similar electronic devices, however, typically contain substances that can be harmful to the environment, such as arsenic, lithium, cadmium, copper, lead, mercury and zinc. If not properly disposed of, these toxic substances can seep into groundwater from decomposing landfills and contaminate the soil with potentiality harmful consequences for humans and the environment.

As an alternative to retailer trade-in or buyback programs, consumers can now recycle and/or sell their used mobile phones using self-service kiosks located in malls, retail stores or other publically accessible areas. Such kiosks are operated by ecoATM, Inc., the assignee of the present application, and are disclosed in, for example, U.S. Pat. Nos. 8,463,646, 8,423,404, 8,239,262, 8,200,533, 8,195,511, and 7,881,965, which are commonly owned by ecoATM, Inc. and are incorporated herein by reference in their entireties.

When offering to purchase used mobiles phones and/or other electronic devices from consumers, it can be important to offer the consumer a suitable price. If the price is too low, the consumer may decline the offer. Conversely, if the price is too high the recycler may be losing potential profits from the enterprise. Accordingly, establishing suitable prices for mobile phones and other electronic devices can be mutually advantageous to both buyer and seller, and doing so may incentivize consumers to dispose of their old electronic devices in an efficient, environmentally conscientious way.

### BRIEF DESCRIPTION OF THE DRAWINGS

FIG. 1 is an isometric view of a machine configured in accordance with an embodiment of the present technology for recycling mobile phones and/or other electronic devices.

FIGS. 2A-2D are a series of isometric views of the machine of FIG. 1 with a number of exterior panels removed to illustrate operation of the machine in accordance with an embodiment of the present technology.

FIG. 3 is a flow diagram of a routine for recycling mobile phones and/or other electronic devices in accordance with an embodiment of the present technology.

FIG. 4 is a flow diagram of a routine for dynamically pricing electronic devices in accordance with an embodiment of the present technology.

FIGS. 5A and 5B are graphs of price margins compared with drop percentages for dynamically pricing electronic devices in accordance with the routine of FIG. 4.

FIG. 6 is a flow diagram of another routine for dynamically pricing electronic devices in accordance with an embodiment of the present technology.

FIGS. 7A and 7B are additional graphs of price margins compared with drop percentages for dynamically pricing electronic devices in accordance with the routine of FIG. 6.

FIG. 8 is a schematic diagram illustrating various components associated with the machine of FIG. 1.

FIG. 9 is a schematic diagram of a suitable distributed computing environment for implementing various aspects of the present technology.

### DETAILED DESCRIPTION

The following disclosure describes various embodiments of systems and methods for determining prices for mobile phones and other consumer electronic devices, and for performing other operations associated with electronic device recycling. Embodiments of the methods described herein can be performed by or with consumer-operated kiosks, networked processing devices, retailer-assisted machines, and/or the like. Some embodiments of the present technology, for example, are directed to consumer-operated kiosks that can perform automatic visual and/or electrical inspections of mobile phones and/or other consumer electronic devices that are submitted to the kiosks for sale or recycling. As described in greater detail below, the visual evaluation or inspection can be performed using one or more cameras or other imaging devices, and the electrical analysis can be performed using a suitable processing device connected to the subject electronic device via, e.g., a suitable electrical connector.

It can be difficult to determine an appropriate price for elastic products with rapidly fluctuating market forces. For example, electronic devices (e.g., mobile phones) can have a rapidly varying market value depending on a number of factors, including the release of new models, the available supply, changing consumer tastes, etc. The traditional approach to determining appropriate prices is through market research. For example, a statistically relevant sample of potential customers is surveyed, presented with different prices, and asked if the customers would purchase (or sell) a product for that price. Feedback allows for determination of an optimal, profit-maximizing price. This traditional approach can be impractical in a used-product industry with ongoing depreciation and highly fluctuating resale prices. The traditional approach also arrives at static values, and does not allow for dynamic pricing without repeating the market research process.

Accordingly, a market-based dynamic pricing approach in accordance with the present technology can provide several benefits over traditional approaches. Dynamic pricing can involve offering a range of different prices for a particular type of electronic device (e.g., a mobile phone of a particular make, model, condition range, and/or region). Based on the consumer response (e.g., the rate at which users accept the offer prices for their electronic devices), an optimal (or near-optimal) price can be selected and applied. In some embodiments, dynamic pricing can involve a large network of kiosks, with dynamic pricing coordinated among the kiosks to arrive at a single optimal or near-optimal price. One approach to dynamic pricing is sequential pricing, in which prices are not varied during a certain timeframe. Rather, prices remain equal for specific device types and at any point in time. After a certain length of time, or a certain number of transactions, the price is adjusted (either higher or lower). With each price change, the user response is evaluated (e.g., the rate at which users accept the offered prices) and it can be determined which price increases profit, and/or which price increases user satisfaction (e.g., as indicated by a high rate of acceptance of the offer).

Another approach to dynamic pricing is parallel pricing, in which multiple different prices are simultaneously offered for the same device type at a number of different kiosks. In a decentralized kiosk system, kiosks or transactions are either chosen randomly, or based on a certain selection criterion (geographic, customer characteristics, time of day, device type, channel, etc.). Different price points are tested simultaneously and reaction of users is measured (e.g., the rate at which users accept the offered prices). By analyzing the user responses at different price points, the price can be adjusted to increase profitability and/or user-satisfaction. These and other aspects of various embodiments of the present technology are described in greater detail below.

There are a number of reasons that using the dynamic pricing methods and systems disclosed herein may be advantageous. For example, the actual market price for a particular electronic device type can fluctuate significantly over time, for example, as new electronic devices are being brought to market virtually every day. Dynamically varying the price in response to market conditions can minimize consumer dissatisfaction while maintaining kiosk operator margins. Varying the price offered for a particular electronic device type can drastically affect the drop rate, for example raising the price offered may increase the drop percentage from 50% to 95%.

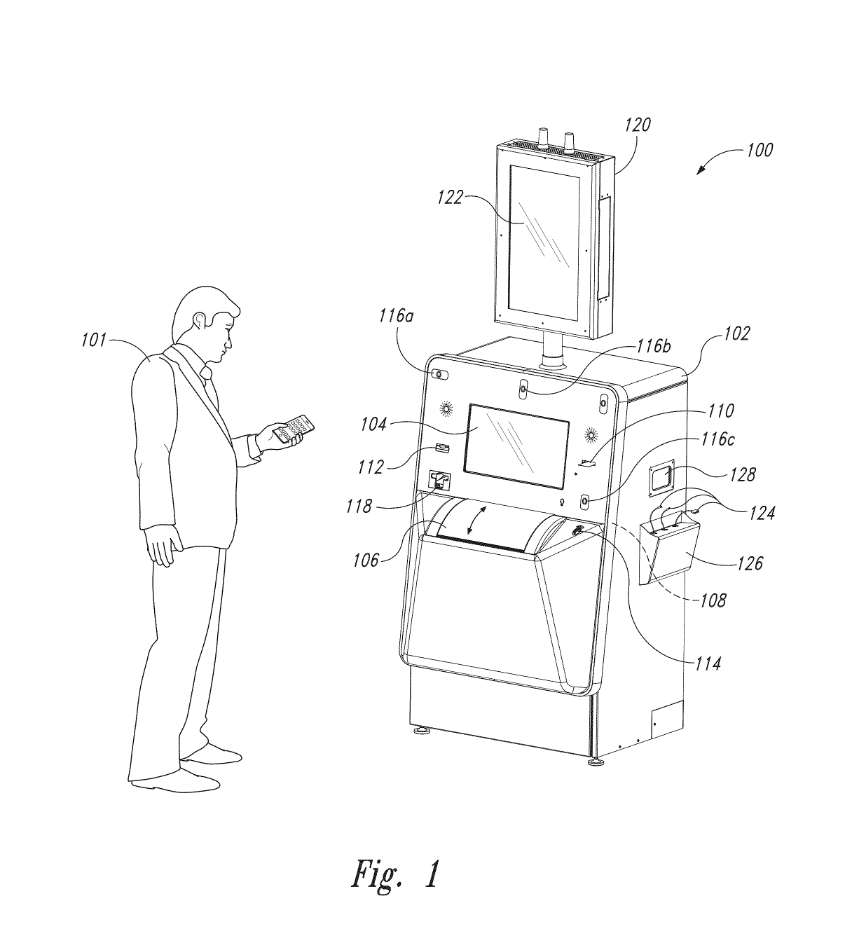

Certain details are set forth in the following description and in FIGS. 1-9 to provide a thorough understanding of various embodiments of the present technology. In other instances, well-known structures, materials, operations and/or systems often associated with smartphones and other handheld devices, consumer electronic devices, computer hardware, software, and network systems, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth. The terminology used below should be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as the position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a kiosk 100 for recycling and/or other processing of mobile phones and other consumer electronic devices in accordance with the present technology. The term “processing” is used herein for ease of reference to generally refer to all manner of services and operations that may be performed or facilitated by the kiosk 100 on, with, or otherwise in relation to an electronic device. Such services and operations can include, for example, selling, reselling, recycling, donating, exchanging, identifying, evaluating, pricing, auctioning, decommissioning, transferring data from or to, reconfiguring, refurbishing, etc., mobile phones and other electronic devices. Although many embodiments of the present technology are described herein in the context of mobile phones, aspects of the present technology are not limited to mobile phones and generally apply to other consumer electronic devices. Such devices include, as non-limiting examples, all manner of mobile phones, smart phones, handheld devices, PDAs, MP3 players, tablet, notebook and laptop computers, e-readers, cameras, etc. In some embodiments, it is contemplated that the kiosk 100 can facilitate selling and/or otherwise processing larger consumer electronic devices, such as desktop computers, TVs, game consoles, etc., as well smaller electronic devices such as Google GlassTM, smart-watches, etc. The kiosk 100 and various features thereof can be at least generally similar in structure and function to the kiosks and corresponding features described in U.S. Pat. Nos. 8,463,646, 8,423,404, 8,239,262, 8,200,533, 8,195,511, and 7,881,965; and in U.S. patent application Ser. Nos. 12/573,089, 12/727,624, 13/113,497, 12/785,465, 13/017,560, 13/438,924, 13/753,539, 13/658,825, 13/733,984, 13/705,252, 13/487,299 13/492,835, 13/562,292, 13/658,828, 13/693,032, 13/792,030, 13/794,814, 13/794,816, 13/862,395 and 13/913,408, each of which is incorporated herein in its entirety by reference. All of the patents and patent applications listed in the preceding sentence are commonly owned by the applicant of the present application, and they along with any other patents or patent applications identified herein are incorporated herein by reference in their entireties. The disclosed technology also includes U.S. patent application Ser. No. 14/498,763, titled “METHODS AND SYSTEMS FOR PRICING AND PERFORMING OTHER PROCESSES ASSOCIATED WITH RECYCLING MOBILE PHONES AND OTHER ELECTRONIC DEVICES,” attorney docket number 111220-8024.US00, filed by the applicant on Sep. 26, 2014; U.S. patent application Ser. No. 14/500,739, titled “MAINTAINING SETS OF CABLE COMPONENTS USED FOR WIRED ANALYSIS, CHARGING, OR OTHER INTERACTION WITH PORTABLE ELECTRONIC DEVICES,” attorney docket number 111220-8025.US00, filed by the applicant on Sep. 29, 2014; U.S. provisional application No. 62/059,129, titled “WIRELESS-ENABLED KIOSK FOR RECYCLING CONSUMER DEVICES,” attorney docket number 111220-8022.US00, filed by the applicant on Oct. 2, 2014; U.S. provisional application No. 62/059,132, titled “APPLICATION FOR DEVICE EVALUATION AND OTHER PROCESSES ASSOCIATED WITH DEVICE RECYCLING,” attorney docket number 111220-8023.US00, filed by the applicant on Oct. 2, 2014; U.S. patent application Ser. No. 14/506,449, titled “SYSTEM FOR ELECTRICALLY TESTING MOBILE DEVICES AT A CONSUMER-OPERATED KIOSK, AND ASSOCIATED DEVICES AND METHODS,” attorney docket number 111220-8035.US00, filed by the applicant on Oct. 3, 2014; U.S. provisional application No. 62/073,840, titled “SYSTEMS AND METHODS FOR RECYCLING CONSUMER ELECTRONIC DEVICES,” attorney docket number 111220-8027.US00, filed by the applicant on Oct. 31, 2014; U.S. provisional application No. 62/073,847, titled “METHODS AND SYSTEMS FOR FACILITATING PROCESSES ASSOCIATED WITH INSURANCE SERVICES AND/OR OTHER SERVICES FOR ELECTRONIC DEVICES,” attorney docket number 111220-8028.US00, filed by the applicant on Oct. 31, 2014; and U.S. provisional application No. 62/076,437, titled “METHODS AND SYSTEMS FOR EVALUATING AND RECYCLING ELECTRONIC DEVICES,” attorney docket number 111220-8038.US00, filed by the applicant on Nov. 6, 2014. All of the patents and patent applications listed in the preceding sentence are commonly owned by the applicant of the present application, and they along with any other patents or patent applications identified herein are incorporated herein by reference in their entireties.

In the illustrated embodiment, the kiosk 100 is a floor-standing self-service kiosk configured for use by a user 101 (e.g., a consumer, customer, etc.) to recycle, sell, and/or perform other operations with a mobile phone or other consumer electronic device. In other embodiments, the kiosk 100 can be configured for use on a countertop or a similar raised surface. Although the kiosk 100 is configured for use by consumers, in various embodiments the kiosk 100 and/or various portions thereof can also be used by other operators, such as a retail clerk or kiosk assistant to facilitate the selling or other processing of mobile phones and other electronic devices.

In the illustrated embodiment, the kiosk 100 includes a housing 102 that is approximately the size of a conventional vending machine. The housing 102 can be of conventional manufacture from, for example, sheet metal, plastic panels, etc. A plurality of user interface devices are provided on a front portion of the housing 102 for providing instructions and other information to users, and/or for receiving user inputs and other information from users. For example, the kiosk 100 can include a display screen 104 (e.g., a liquid crystal display (“LCD”) or light emitting diode (“LED”) display screen, a projected display (such as a heads-up display or a head-mounted device), and so on) for providing information, prompts, etc., to users. The display screen 104 can include a touch screen for receiving user input and responses to displayed prompts. In addition or alternatively, the kiosk 100 can include a separate keyboard or keypad for this purpose. The kiosk 100 can also include an ID reader or scanner 112 (e.g., a driver's license scanner), a fingerprint reader 114, and one or more cameras 116 (e.g., digital still and/or video cameras, identified individually as cameras 116a-c). The kiosk 100 can additionally include output devices such as a label printer having an outlet 110, and a cash dispenser having an outlet 118. Although not identified in FIG. 1, the kiosk 100 can further include a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), a receipt or voucher printer and dispenser, as well as other user input and output devices. The input devices can include a touchpad, pointing device such as a mouse, joystick, pen, game pad, motion sensor, scanner, eye direction monitoring system, etc. Additionally the kiosk 100 can also include a bar code reader, QR code reader, bag/package dispenser, a digital signature pad, etc. In the illustrated embodiment, the kiosk 100 additionally includes a header 120 having a display screen 122 for displaying marketing advertisements and/or other video or graphical information to attract users to the kiosk. In addition to the user interface devices described above, the front portion of the housing 102 also includes an access panel or door 106 located directly beneath the display screen 104. As described in greater detail below, the access door is configured to automatically retract so that the user 101 can place an electronic device (e.g., a mobile phone) in an inspection area 108 for automatic inspection by the kiosk 100.

A sidewall portion of the housing 102 can include a number of conveniences to help users recycle or otherwise process their mobile phones. For example, in the illustrated embodiment the kiosk 100 includes an accessory bin 128 that is configured to receive mobile device accessories that the user wishes to recycle or otherwise dispose of. Additionally, the kiosk 100 can provide a free charging station 126 with a plurality of electrical connectors 124 for charging a wide variety of mobile phones and other consumer electronic devices.

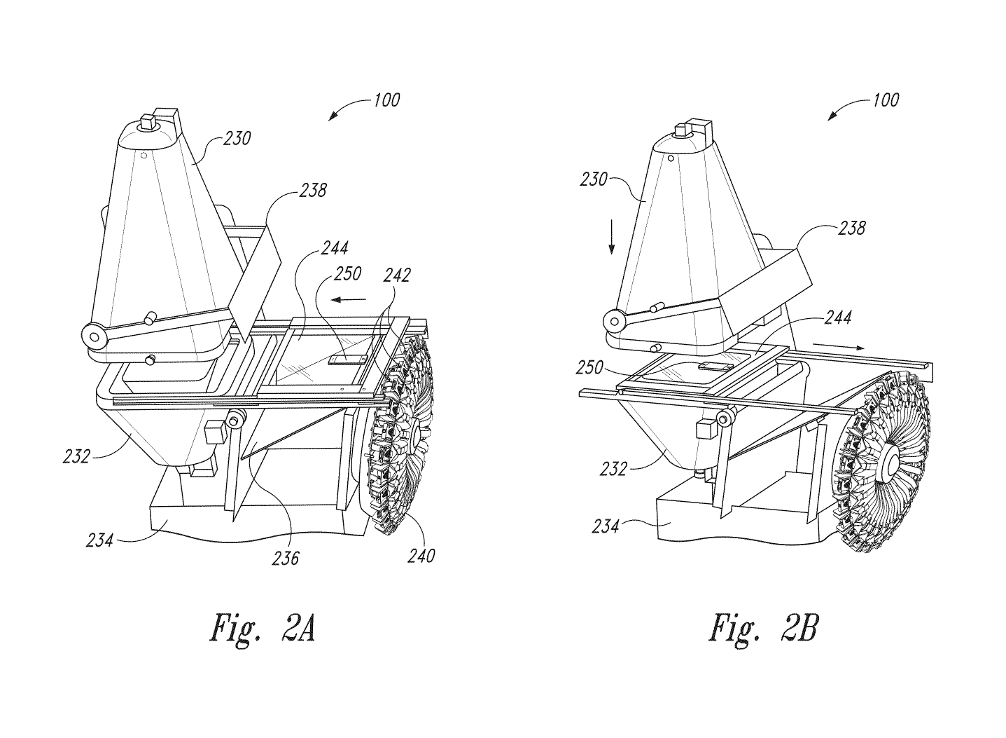

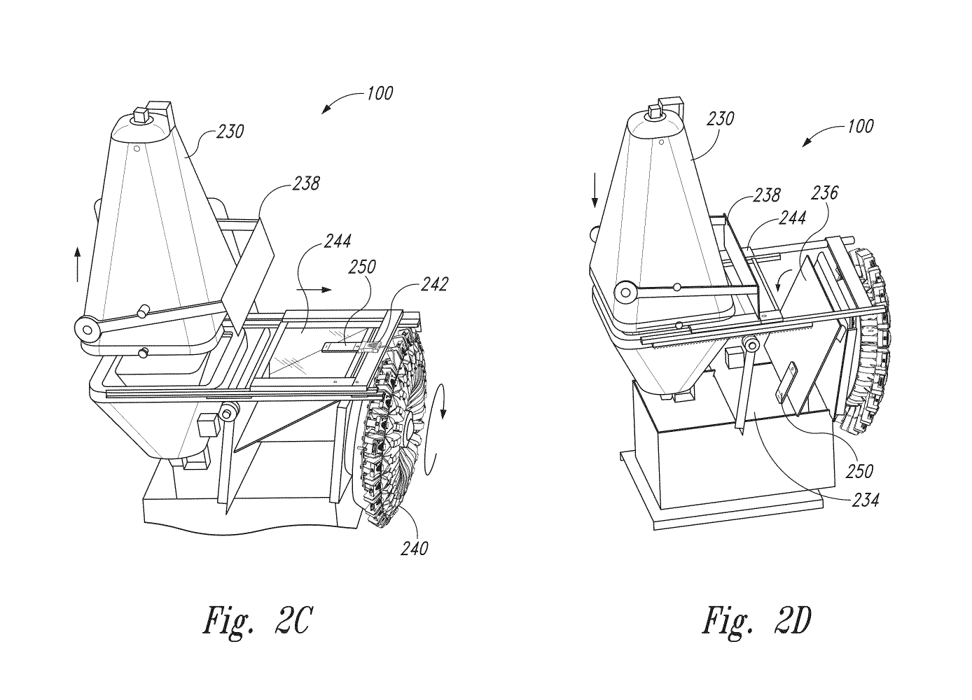

FIGS. 2A-2D are a series of isometric views of the kiosk 100 with the housing 102 removed to illustrate selected internal components configured in accordance with an embodiment of the present technology. Referring first to FIG. 2A, in the illustrated embodiment the kiosk 100 includes a connector carrier 240 and an inspection plate 244 operably disposed behind the access door 106 (FIG. 1). In the illustrated embodiment, the connector carrier 240 is a rotatable carrousel that is configured to rotate about a generally horizontal axis and carries a plurality of electrical connectors 242 (e.g., approximately 25 connectors) distributed around an outer periphery thereof. In other embodiments, other types of connector carrying devices (including both fixed and movable arrangements) can be used. In some embodiments, the connectors 242 can include a plurality of interchangeable USB connectors configured to provide power and/or exchange data with a variety of different mobile phones and/or other electronic devices. In operation, the connector carrier 240 is configured to automatically rotate about its axis to position an appropriate one of the connectors 242 adjacent to an electronic device, such as a mobile phone 250, that has been placed on the inspection plate 244 for recycling. The connector 242 can then be manually and/or automatically withdrawn from the connector carrier 240 and connected to a port on the mobile phone 250 for electrical analysis. Such analysis can include, e.g., an evaluation of the make, model, configuration, condition, etc., using one or more of the methods and/or systems described in detail in the commonly owned patents and patent applications identified herein and incorporated by reference in their entireties.

In the illustrated embodiment, the inspection plate 244 is configured to translate back and forth (on, e.g., parallel mounting tracks) to move an electronic device, such as the mobile phone 250, between a first position directly behind the access door 106 and a second position between an upper chamber 230 and an opposing lower chamber 232. Moreover, in this embodiment the inspection plate 244 is transparent, or at least partially transparent (e.g., formed of glass, Plexiglas, etc.) to enable the mobile phone 250 to be photographed and/or otherwise optically evaluated from all, or at least most viewing angles (e.g., top, bottom, sides, etc.) using, e.g., one or more cameras, mirrors, etc. mounted to or otherwise associated with the upper and lower chambers 230 and 232. When the mobile phone 250 is in the second position, the upper chamber 230 can translate downwardly to generally enclose the mobile phone 250 between the upper chamber 230 and the lower chamber 232. The upper chamber 230 is operably coupled to a gate 238 that moves up and down in unison with the upper chamber 230. As noted above, in the illustrated embodiment the upper chamber 230 and/or the lower chamber 232 can include one or more cameras, magnification tools, scanners (e.g., bar code scanners, infrared scanners, etc.) or other imaging components (not shown) and an arrangement of mirrors (also not shown) to view, photograph and/or otherwise visually evaluate the mobile phone 250 from multiple perspectives. In some embodiments, one or more of the cameras and/or other imaging components discussed above can be movable to facilitate device evaluation. The inspection area 108 can also include weight scales, heat detectors, UV readers/detectors, and the like, for further evaluation of electronic devices placed therein. The kiosk 100 can further include an angled binning plate 236 for directing electronic devices from the transparent plate 244 into a collection bin 234 positioned in a lower portion of the kiosk 100.

The kiosk 100 can be used in a number of different ways to efficiently facilitate the recycling, selling and/or other processing of mobile phones and other consumer electronic devices. Referring to FIGS. 1-2D together, in one embodiment a user wishing to sell a used mobile phone, such as the mobile phone 250, approaches the kiosk 100 and identifies the type of device the user wishes to sell in response to prompts on the display screen 104. Next, the user may be prompted to remove any cases, stickers, or other accessories from the device so that it can be accurately evaluated. Additionally, the kiosk 100 may print and dispense a unique identification label (e.g., a small adhesive-backed sticker with a quick response code (“QR code”), barcode, or other machine-readable indicia, etc.) from the label outlet 110 for the user to adhere to the back of the mobile phone 250. After this is done, the door 106 retracts and opens allowing the user to place the mobile phone 250 onto the transparent plate 244 in the inspection area 108 (FIG. 2A). The door 106 then closes and the transparent plate 244 moves the mobile phone 250 under the upper chamber 230 as shown in FIG. 2B. The upper chamber 230 then moves downwardly to generally enclose the mobile phone 250 between the upper and lower chambers 230 and 232, and the cameras and/or other imaging components in the upper and lower chambers 230 and 232 perform a visual inspection of the mobile phone 250. In some embodiments, the visual inspection can include a computer-implemented visual analysis (e.g., a three-dimensional (“3D”) analysis) performed by a processing device within the kiosk (e.g., a CPU) to confirm the identification of the mobile phone 250 (e.g. make, model and/or sub-model) and/or to evaluate or assess the condition and/or function of the mobile phone 250 and/or its various components and systems. For example, the visual analysis can include computer-implemented evaluation (e.g., a digital comparison) of images of the mobile phone 250 taken from top, side and/or end view perspectives to determine length, width, and/or height (thickness) dimensions of the mobile phone 250. The visual analysis can further include a computer-implemented inspection of a display screen on the mobile phone 250 to check for, e.g., cracks in the glass and/or other damage or defects in the LCD (e.g., defective pixels, etc.). In some embodiments, the kiosk 100 can perform the visual analysis using one or more of the methods and/or systems described in detail in the commonly owned patents and patent applications identified herein and incorporated by reference in their entireties.

Referring next to FIG. 2C, after the visual analysis is performed and the device has been identified, the upper chamber 230 returns to its upper position and the transparent plate 244 returns the mobile phone 250 to its initial position near the door 106. The display screen 104 can also provide an estimated price, or an estimated range of prices, that the kiosk 100 may offer the user for the mobile phone 250 based on the visual analysis, and/or based on user input (e.g., input regarding the type, condition, etc. of the phone 250). If the user indicates (via, e.g., input via the touch screen) that they wish to proceed with the transaction, the connector carrier 240 automatically rotates an appropriate one of the connectors 242 into position adjacent the transparent plate 244, and door 106 is again opened. The user can then be instructed (via, e.g., the display screen 104) to withdraw the selected connector 242 (and its associated wire) from the carrousel 240, plug the connector 242 into the corresponding port (e.g., a USB port) on the mobile phone 250, and reposition the mobile phone 250 in the inspection area on the transparent plate 244. After doing so, the door 106 once again closes and the kiosk 100 (e.g. the kiosk CPU) performs an electrical inspection of the device via the connector 242 to further evaluate the condition of the phone as well as specific component and operating parameters such as the memory, carrier, etc. In addition or alternatively, in some embodiments the electrical inspection can include a determination of phone manufacturer information (e.g., a vendor identification number or VID) and product information (e.g., a product identification number or PID). In some embodiments, the kiosk 100 can perform the electrical analysis using one or more of the methods and/or systems described in detail in the commonly owned patents and patent applications identified herein and incorporated by reference in their entireties.

After the visual and electronic analysis of the mobile phone 250, the user is presented with a phone purchase price via the display screen 104. If the user declines the price (via, e.g., the touch screen), a retraction mechanism (not shown) automatically disconnects the connector 242 from the mobile phone 250, the door 106 opens, and the user can reach in and retrieve the mobile phone 250. If the user accepts the price, the door 106 remains closed and the user may be prompted to place his or her identification (e.g., a driver's license) in the ID scanner 112 and provide a thumbprint via the fingerprint reader 114. As a fraud prevention measure, the kiosk 100 can be configured to transmit an image of the driver's license to a remote computer screen, and an operator at the remote computer can visually compare the picture (and/or other information) on the driver's license to an image of the person standing in front of the kiosk 100 as viewed by one or more of the cameras 116a-c (FIG. 1) to confirm that the person attempting to sell the phone 250 is in fact the person identified by the driver's license. In some embodiments, one or more of the cameras 116a-c can be movable to facilitate viewing of kiosk users, as well as other individuals in the proximity of the kiosk 100. Additionally, the person's fingerprint can be checked against records of known fraud perpetrators. If either of these checks indicate that the person selling the phone presents a fraud risk, the transaction can be declined and the mobile phone 250 returned. After the user's identity has been verified, the transparent plate 244 moves back toward the upper and lower chambers 230 and 232. As shown in FIG. 2D, however, when the upper chamber 230 is in the lower position the gate 238 permits the transparent plate 244 to slide underneath but not electronic devices carried thereon. As a result, the gate 238 knocks the mobile phone 150 off of the transparent plate 244, onto the binning plate 236 and into the bin 234. The kiosk can then provide payment of the purchase price to the user. In some embodiments, payment can be made in the form of cash dispensed from the cash outlet 118. In other embodiments, the user can receive remuneration for the mobile phone 150 in various other useful ways. For example, the user can be paid via a redeemable cash voucher, a coupon, an e-certificate, a prepaid card, a wired or wireless monetary deposit to an electronic account (e.g., a bank account, credit account, loyalty account, online commerce account, mobile wallet etc.), Bitcoin, etc.

As those of ordinary skill in the art will appreciate, the foregoing routines are but some examples of ways in which the kiosk 100 can be used to recycle or otherwise process consumer electronic devices such as mobile phones. Although the foregoing example is described in the context of mobile phones, it should be understood that the kiosk 100 and various embodiments thereof can also be used in a similar manner for recycling virtually any consumer electronic device, such as MP3 players, tablet computers, PDAs, and other portable devices, as well as other relatively non-portable electronic devices such as desktop computers, printers, devices for implementing games, entertainment or other digital media on CDs, DVDs, Blu-ray, etc. Moreover, although the foregoing example is described in the context of use by a consumer, the kiosk 100 in various embodiments thereof can similarly be used by others, such as a store clerk, to assist consumers in recycling, selling, exchanging, etc. their electronic devices.

The Figures described herein and below include representative flow diagrams and other information that depict processes used in some embodiments of the present technology. These flow diagrams may not show all functions or exchanges of data, but instead they provide an understanding of commands and data exchanged under the systems described herein. Those skilled in the relevant art will recognize that some functions or exchange of commands and data may be repeated, varied, omitted, or supplemented, and other (less important) aspects not shown may be readily implemented. Those skilled in the art will appreciate that the blocks shown in the flow diagrams discussed below may be altered in a variety of ways. For example, while processes or blocks are presented in a given order, alternative implementations may perform routines in a different order, and some processes or blocks may be rearranged, deleted, moved, added, subdivided, combined, and/or modified to provide alternative or sub-combinations. Each of these processes or blocks may be implemented in a variety of different ways. Also, although processes or blocks are at times shown as being performed in series, these processes or blocks may instead be performed or implemented in parallel, or may be performed at different times. The steps depicted in the flow diagrams and/or represented by other tables, formulas, etc. can themselves include a sequence of operations that need not be described herein. Those of ordinary skill in the art can create source code, microcode, program logic arrays and/or or computer-readable instructions to implement the depicted steps and routines based on the flowcharts and the detailed description provided herein. The routines and portions thereof can be stored in non-volatile memory that forms part of a processor contained in the kiosk 100 or otherwise associated with the kiosk 100 (e.g., a remote processor operably connected to the kiosk 100 via a wired/wireless communication link, etc.), or they can be stored in removable media, such as disks, or hardwired or preprogrammed in chips, such as EEPROM semiconductor chips.

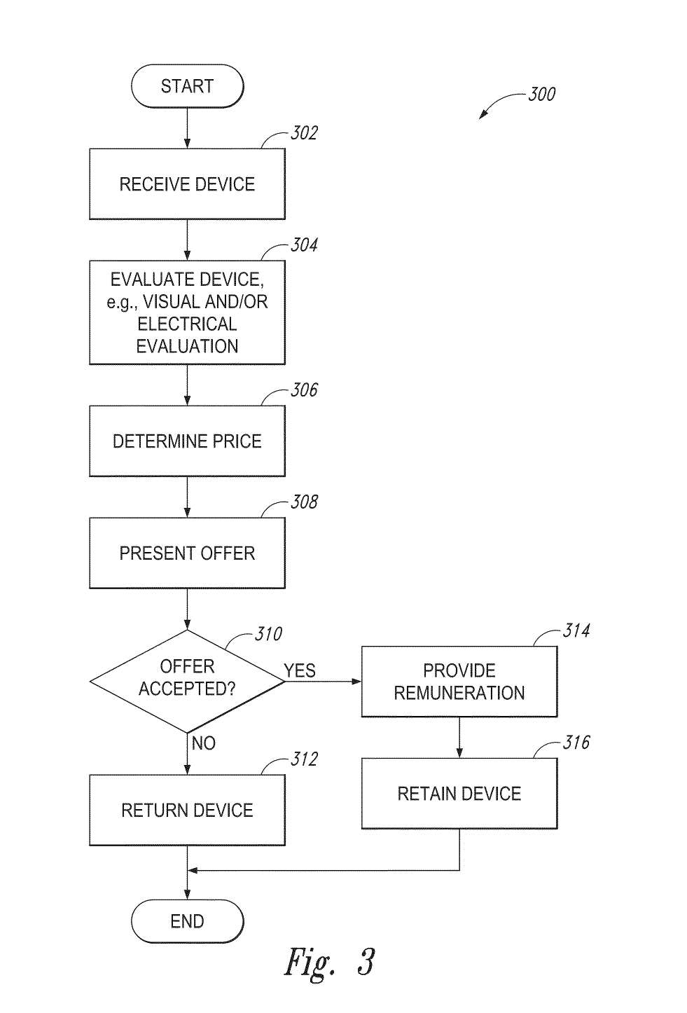

FIG. 3 is a flow diagram of a routine 300 that can be performed by the kiosk 100 for purchasing devices, e.g., mobile phones and/or other electronic devices, from users in accordance with an embodiment of the present technology. The routine can be executed by a processing device in accordance with computer-executable instructions stored on memory. In step or block 302, the routine receives the device from the user (e.g., in the inspection area 108 of the kiosk 100 (FIG. 1)). In block 304, the routine performs an evaluation, e.g., a visual and/or electrical inspection of the device, to determine various information about the device that can affect the device value. Such information can include, for example, the make, model, sub-model of the device, the device features (e.g., memory size, cell service carrier, etc.), device operability, device charge and/or rechargeability, physical condition, display function and condition, etc. After the device has been evaluated, the routine proceeds to block 306 to determine a price to offer the user for the device. In block 308, the routine presents the offer to the user (via, e.g., a textual message on the display screen 104, an audio speaker, etc.). In decision block 310, the routine determines if the user has accepted the offer price (by, e.g., providing input via a touch screen, key pad, microphone, etc. operably coupled to the kiosk 100). If the user declines the offer, the routine proceeds to block 312 and returns the device to the user. Conversely, if the user accepts the offer, the routine proceeds to block 314 and provides remuneration to the user in the amount of the purchase price. Such remuneration or payment can be in the form of, e.g., cash, a voucher redeemable for cash, merchandise, services, etc., electronic value (e.g., bitcoin, e-certificates, credit to electronic payment account, etc.), credit (e.g., a prepaid credit card, debit card, gift card, etc.), coupons, loyalty points, and/or other forms of value. In block 316, the routine retains the device (e.g., in the collection bin 234 of the kiosk 100) and the routine ends.

As discussed above, it can be important to offer the user what the user perceives as a “fair” price for the device to incentivize the user to sell the device. Moreover, it can also be important to determine a price that provides the kiosk operator (retailer, or other commercial enterprise) with a sufficient profit margin for providing the device recycling service. In some instances, however, it can be difficult to correctly identify such a price in view of rapidly fluctuating market conditions. For example, in the case of a mobile phone, the price a user may accept for a particular phone can vary from one day to the next if a new model is released. Without a sufficient understanding of the market conditions for a device of a particular type, it can be difficult to accurately determine a fair price for the device that is mutually beneficial to the seller (e.g., the kiosk user) and the buyer (e.g., the kiosk operator, retailer, etc.).

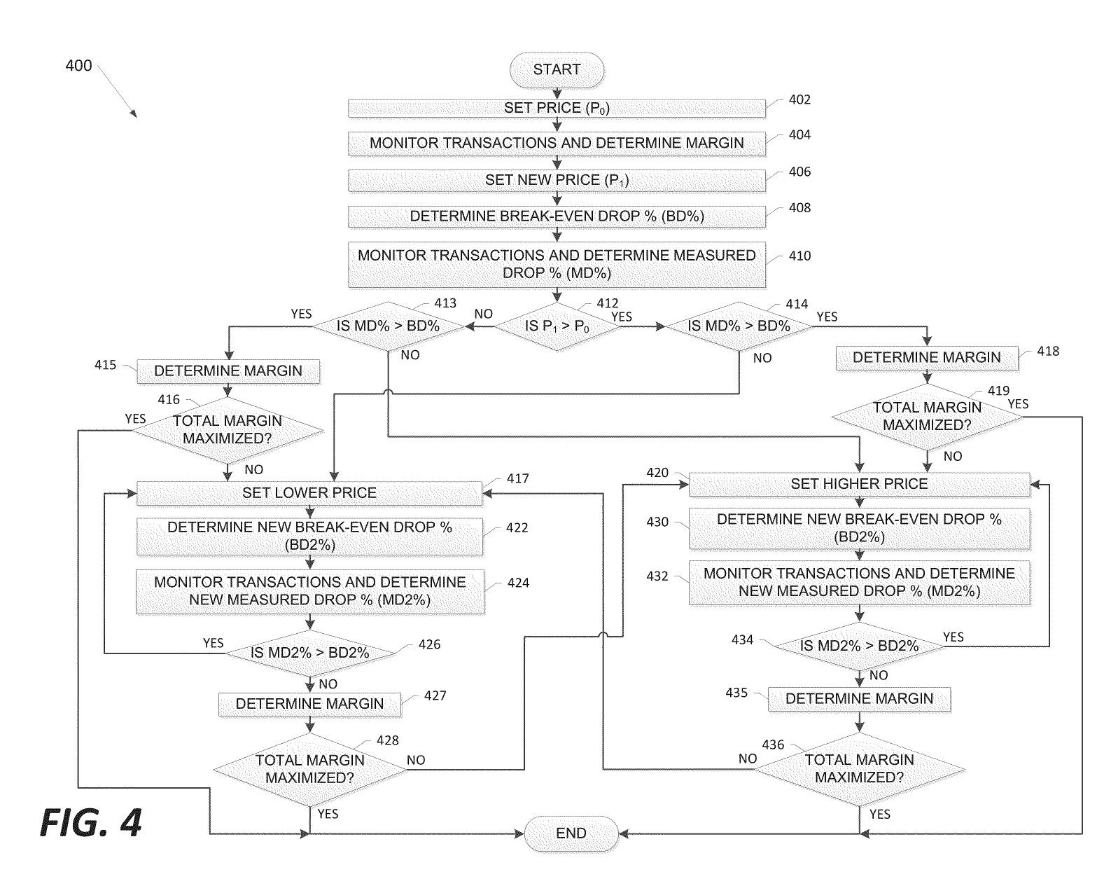

FIG. 4 is a flow diagram of a routine 400 for dynamically pricing electronic devices. In particular, the routine is directed to sequential iterative dynamic pricing, in which user responses are evaluated in response to a price change and, based on the responses, the price is changed yet again until an acceptable price point has been reached. In block 402, the routine begins by setting an initial price (P₀) for a particular type of electronic device (e.g., a Galaxy S4 smartphone). The particular electronic device type can be defined as a narrow grouping which includes only a particular make, model, year, etc., or it can include a variety of different makes, models, and years that are grouped together as having similar visual, electronic, and/or market characteristics. The electronic device type can also include an evaluation of the condition of the device, for example a functioning screen, any scratches, operating battery, etc. As indicated above, the kiosk can evaluate an electronic device visually and electronically. This evaluation can be used to determine the electronic device type for the particular device that a user has presented at the kiosk. In block 404, the routine continues with monitoring transactions and determining a margin for P₀. For example, at either a single kiosk or across multiple kiosks in a network, the price P₀ can be offered to all users who present the specified electronic device type. The transactions are monitored to evaluate the conversation rate, also referred to herein as the drop rate (e.g., the number of users who accept P₀ as a percentage of all users who are offered P₀). The margin is also calculated for the price P₀. The margin is the difference between the value of the electronic device to the kiosk operator (e.g., for resale, recycling, etc.) and the price P₀. The margin can be expressed as a percentage or as an absolute dollar amount. For example, a 5% margin indicates that the kiosk operator values the electronic device at 105% of the value of P₀. The margin can be multiplied by the number of electronic devices purchased to determine a total margin at price P₀. For example, if each electronic device has a margin of $10 at P₀, and 100 users accept the offer over a given period of time, then the total margin at P₀ is $1,000.

In block 406, the routine sets a new price (P₁), which is different than P₀. The new price can be determined randomly initially, or can be predetermined based the kiosk operator's input. In block 408, a break-even drop percentage (BD %) is determined for the new price P₁. The break-even drop percentage is the drop percentage (e.g., the percentage of users accepting the offer at P₁) for a given period of time at which the total margin will be the same as the total margin as measured when the price was P₀. If the price is dropped from P₀ to P₁, then the drop percentage must increase in order for the total margin to remain the same for a given period of time. Conversely, if the price is raised from P₀ to P₁, then the drop percentage can decrease in order for the total margin to remain the same. The determined break-even drop percentage (BD %) provides a target drop rate at the new price, and a benchmark against which to evaluate performance in the market at P₁. In block 410, the routine monitors transactions at price P₁ and determines a measured drop percentage (MD %). The measured drop percentage is the actual percentage of users who accept the offer at price P₁.

In decision block 412, P₀ is compared with P₁. If P₀ is greater than P₁ (i.e., the price dropped from P₀ to P₁), then the routine proceeds to decision block 413. If, conversely, P₀ is less than P₁ (i.e., the price rose from P₀ to P₁), then the routine proceeds to decision block 414. In decision block 413, the measured drop percentage (MD %) at P₁ is compared with the break-even drop percentage (BD %) at P₁. If the measured drop percentage is greater than the break-even drop percentage (e.g., the total margin was greater at P₁ than at P₀), then the routine proceeds to block 415 and determines the margin. In block 416, the routine determines whether total margin has been maximized. If total margin has been maximized, then the routine concludes. If total margin has not been maximized, then the routine proceeds to block 417 and sets a lower price. If the measured drop percentage is less than the break-even drop percentage (e.g., the total margin was lower at P₁ than at P₀), then the routine proceeds to block 418 to determine the margin. In block 419, the routine determines whether total margin has been maximized. If the total margin has been maximized, then the routine concludes. If total margin has not been maximized, then the routine proceeds to block 420 and sets a higher price. This reflects the fact that since the price was lowered from P₀ to P₁, if the total margin went up, then the next step should be to decrease the price further in an effort to maximize the total margin. Conversely, if the total margin went down, then the new price should be higher, since lowering the price to P₁ resulted in a drop in total margin.

A similar evaluation is carried out in the situation in which the price was raised from P₀ to P₁. In decision block 414, the measured drop percentage (MD %) for P₁ is compared with the break-even drop percentage (BD %) for P₁. If the measured drop percentage is greater than the break-even drop percentage (i.e., the total margin rose from P₀ to P₁), then the routine proceeds to block 420 and sets a higher price. If the measured drop percentage is less than the break-even drop percentage (i.e., the total margin dropped from P₀ to P₁), then the routine proceeds to block 417 and sets a lower price. This reflects the fact that since the price was raised from P₀ to P₁, if the total margin went up, then the next step should be to increase the price further in an effort to maximize the total margin. Conversely, if the total margin went down, then the price should be lower, since raising the price to P₁ resulted in a drop in total margin.

From block 417, the routine continues to block 422 to determine a new break-even drop percentage (BD2%) for the new price. This is the drop percentage (i.e., the percentage of users who accept the offered price) at which the total margin at the new price will be equal to the total margin at the previous price. In block 424, the routine monitors transactions and determines a new measured drop percentage (MD2%). The break-even drop percentage (BD2%) and measured drop percentage (MD2%) are compared in decision block 426. If the measured drop percentage (MD2%) is greater than the break-even drop percentage (BD2%) (i.e., the total margin went up from the previous price to the new price), then the routine returns to block 417 to set a still lower price. This again reflects the understanding that if lowering the price further to the new price resulted in an increase in total margin, then the next step should be to lower the price further still. Conversely, if in decision block 426 the measured drop percentage (MD2%) is lower than or equal to the break-even drop percentage (BD2%) (i.e., total margin went down from the previous price to the new price), then the routine continues in block 427 to determine the margin, and then in block 428 to determine whether total margin has been maximized or approximately maximized. If the total margin has not been maximized, then the routine continues to block 420 to set a higher price. This reflects the understanding that, since lowering the price reduced total margin, the next step towards maximizing margin would be to increase the price. If the total margin has been maximized, then the routine is complete.

Returning to block 420, once the higher price has been set, the routine continues in block 430 by determining a new break-even drop percentage (BD2%), and in block 432 monitors transactions and determines the new measured drop percentage (MD2%). The measured drop percentage (MD2%) is compared to the break-even drop percentage (BD2%) in decision block 434. If the measured drop percentage (MD2%) is greater than the break-even drop percentage (BD2%) (i.e., total margin increased with the previous price rise), then the routine returns to block 420 and sets a higher price. Since raising the price resulted in an increase in margin, the next step is to increase the price further. If, conversely, the measured drop percentage (MD2%) is less than or equal to the break-even drop percentage (BD2%) (i.e., the total margin decreased with the previous price rise), then the routine continues in block 435 to determine the margin, and then proceeds to block 436 to determine whether total margin has been maximized. If the total margin has not been maximized, then the routine returns to block 417 and sets a lower price. Since raising the price here resulted in a decrease in margin, the next step in the routine is to set a lower price. If the total margin has been maximized, then the routine is complete.

The determination that total margin has been maximized (blocks 415, 418, 428 and 436) can be made based on a number of criteria. For example, the iterative process of the routine can result in continued honing in on an optimal or near-optimal price point, particularly if the magnitude of price changes from one iteration to the next decrease over time. After a certain number of iterations, it may be determined that a further change in price will not lead to a further increase in total margin, i.e., the total margin has been maximized or nearly maximized. This may be a price that is sufficiently near to a theoretical optimal price as to be considered acceptable by the operators.

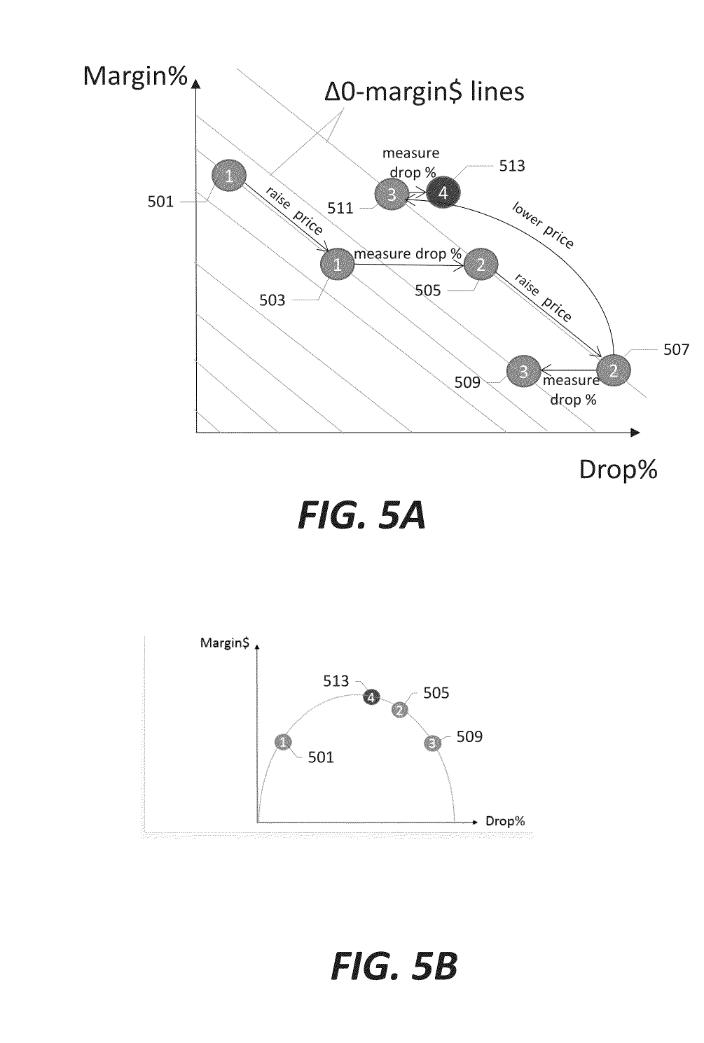

FIGS. 5A and 5B are example graphs of price margins compared with drop percentages for dynamically pricing electronic devices in accordance with one example of the routine of FIG. 4. Referring to FIG. 5A, the horizontal axis is the drop percentage (i.e., the percentage of users who are offered the price for a particular electronic device type and who accept the offered price) and the vertical axis is the margin percentage (i.e., the difference between the value of the electronic device to the kiosk operator (e.g., for resale, recycling, etc.) and the price expressed as a percentage). The diagonal lines indicate the break-even points for various total margin levels, such that at each point along an individual line, the total profit margin is the same. The graph illustrates a process of dynamic pricing for a particular electronic device type (e.g., a particular type of smartphone), in which an initial price is selected and a drop percentage is measured, reflected by point 501. Next, a new, higher price is selected as reflected by point 503. At the new price, the drop percentage must increase for point 503 in order to maintain the same total margin as point 501. Accordingly, point 503 lies along the same total margin line as point 501. The drop percentage of point 503 reflects a break-even percentage. Next, the price of 503 is applied to purchase the electronic devices from users, and the user response is evaluated to obtain a measured drop percentage, which is reflected by point 505. Since the measured drop percentage at 505 is higher than the break-even drop percentage at 503, the increase in price has resulted in an increase in total margin.

Next, a new, higher price is selected to arrive at point 507. Point 507 falls along the same total margin line as point 505, providing a break-even drop percentage. Next, the price at 507 is applied and the user response is evaluated to obtain a measured drop percentage, which is reflected in point 509. In this example, the measured drop percentage is lower than the break-even drop percentage, and so the increase in price from point 505 to point 507 has resulted in a decrease in total margin. Accordingly, the next step is to decrease the price from point 507 to point 511. Again, point 511 falls along the same total margin line as point 507, providing a new, lower, break-even percentage. The price corresponding to point 511 is then applied and user response evaluated to determine a measured drop percentage, reflected by point 513. Here, the measured drop percentage is greater than the break-even percentage, and accordingly total margin has been increased by lowering the price to the price corresponding to 511. This process can be repeated iteratively until the operator is satisfied that the total margin has been maximized or nearly maximized. In some embodiments, the magnitude of the price change between measurements can continually decrease as an optimal price is approached.

FIG. 5B illustrates a graph of the drop percentage along the horizontal axis and the total margin on the vertical axis. Points 501, 505, 509, and 513 are plotted. Each of these points reflects a measured drop percentage at a particular price. As illustrated, the total margin follows an inverse U-shaped curve with respect to the drop percentage, such that the maximized total margin falls in a middle range of drop percentage, with point 513 reflecting the highest measured total profit margin obtained via the iterative process described above.

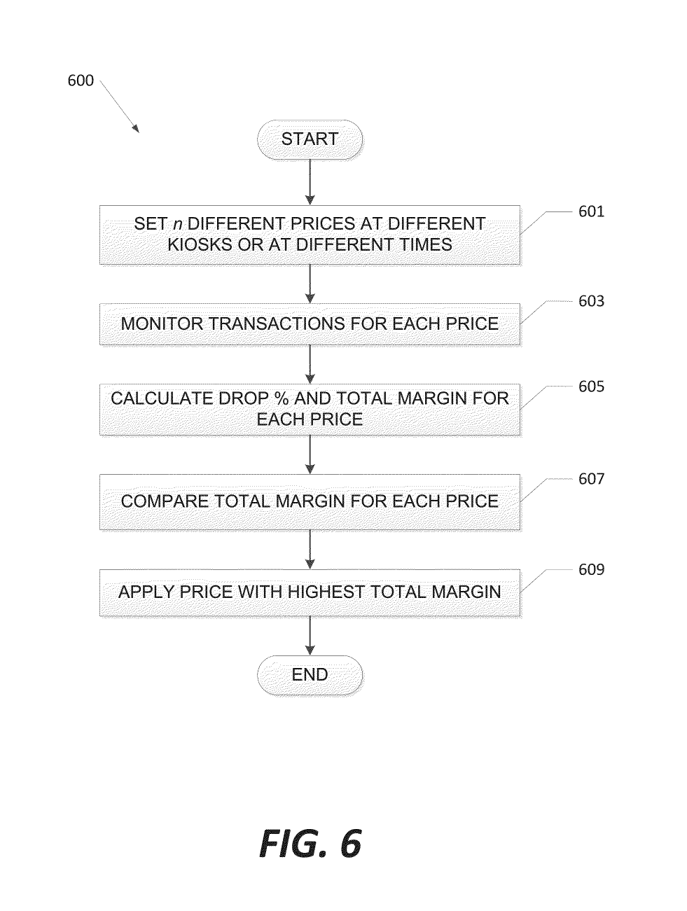

FIG. 6 is a flow diagram of a routine 600 for dynamically pricing electronic devices in accordance with another embodiment of the present technology. In particular, the routine is directed to parallel dynamic pricing, in which a number of different prices for the same electronic device type are offered at different kiosks simultaneously, and user responses are then evaluated to determine an optimal or near-optimal price. Alternatively, a number of different prices can be tested at different times (either at a single kiosk or distributed across a network of kiosks), and then the response to all the different prices can be evaluated together. The routine begins in block 601 with setting n different prices at different kiosks or at different times. For example, five different prices can be applied simultaneously at five different groups of kiosks for a given electronic device type (e.g., a given model and memory size of smartphone). Alternatively, five different prices can be applied to a group of kiosks over a period of five days, for example, for the same type of electronic device. In block 603, the routine monitors transactions for each price, and in block 605 the routine calculates a drop percentage and total margin for each price. In block 607, the routine compares the total margin for each price. The routine then selects the price corresponding to the highest total margin, and in block 609 applies this price to the kiosk or group of kiosks.

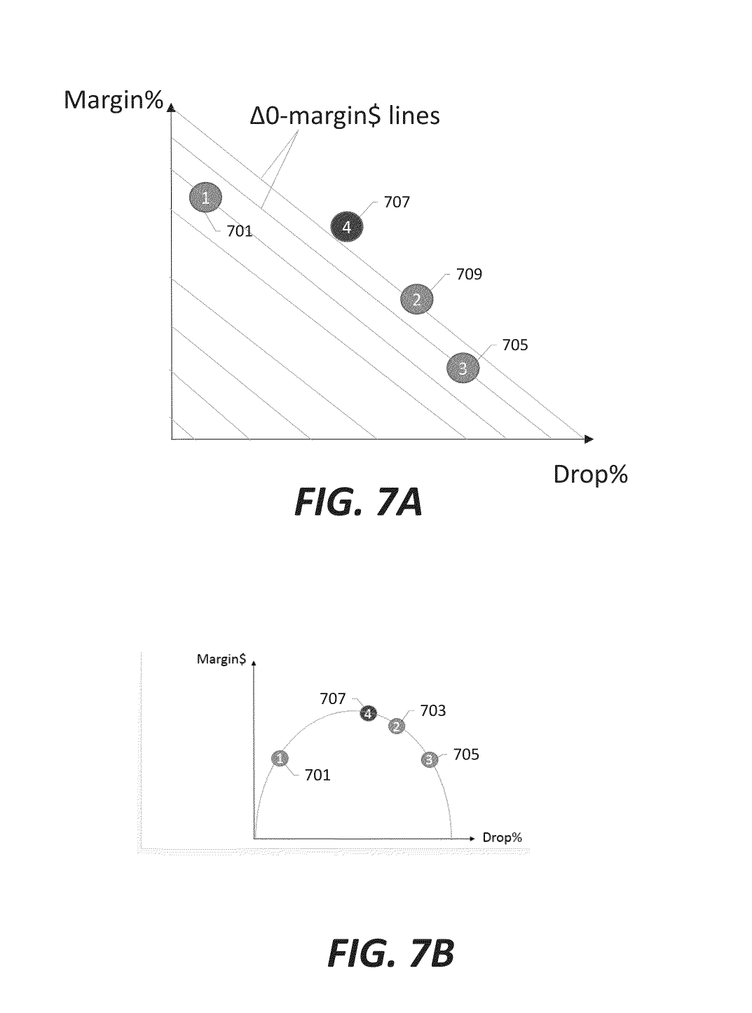

FIGS. 7A and 7B are additional graphs of price margins compared with drop percentages for dynamically pricing electronic devices in accordance with the routine of FIG. 6. With reference to FIG. 7A, the horizontal axis is the drop percentage (i.e., the percentage of users who accept the offered price) and the vertical axis is the margin percentage (i.e., the percentage margin for a particular electronic device type at a given period). The diagonal lines indicate the break-even points for various total margin levels, such that at each point along an individual line, the total margin is the same. In the routine illustrated in FIG. 6, a number of different prices are selected ahead of time, and then applied either in parallel to different kiosks or groups of kiosks, or else applied to the same kiosk or group of kiosks in sequence over time. The four prices selected each correspond to a measured drop percentage as reflected by points 701, 703, 705, and 709 in FIG. 7A. The number of different prices selected for testing and evaluation can vary. FIG. 7B illustrates a graph of the drop percentage along the horizontal axis and the total margin on the vertical axis. Points 701, 703, 705, and 709 are plotted. Each of these points reflects a measured drop percentage at a particular price. As illustrated, the total margin again follows an inverse U-shaped curve with respect to the drop percentage, such that the maximized total margin falls in a middle range of drop percentage, with point 707 reflecting the highest measured profit margin.

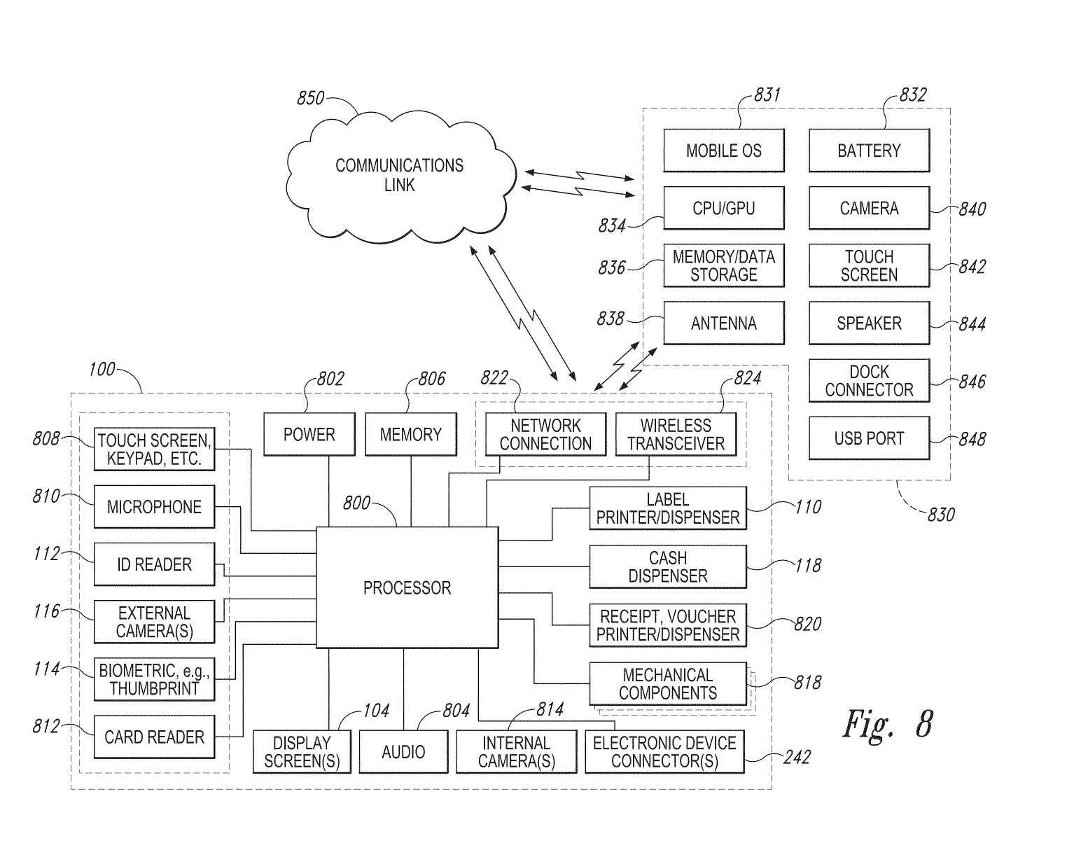

The flow diagrams described herein (e.g., those described with reference to FIGS. 3, 4, and 6) are representative flow diagrams that depict routines and processes used in some embodiments. These processes and routines can be executed by a processing device, such as a processor or CPU associated with the kiosk 100 (as described below with reference to, e.g., FIG. 8), an associated server computer, wireless device, personal computer, etc. in accordance with computer-executable instructions stored on a computer-readable medium. In some embodiments, the dynamic pricing routines disclosed herein can be performed by computing devices that are separate from a kiosk, for example a user's home computer, a mobile electronic device (e.g., smartphone or tablet), etc. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein and refer to any of the above devices and systems, as well as any data processor. These flow diagrams may not show all functions or exchanges of data, but instead they provide an understanding of commands and data exchanged under the system. Those skilled in the relevant art will recognize that some functions or exchange of commands and data may be repeated, varied, omitted, or supplemented, and other (less important) aspects not shown may be readily implemented. For example, while processes or blocks are presented in a given order, alternative implementations may perform routines having steps, or employ systems having blocks in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Various steps depicted in the flow diagrams can be of a type well known in the art and can itself include a sequence of operations that need not be described herein. Those of ordinary skill in the art can create source code, microcode, program logic arrays or otherwise implement the inventions described herein based on the Figures and the detailed description provided herein. The routines described above can be stored in non-volatile memory, or in removable media, such as disks, or hardwired or preprogrammed in chips, such as EEPROM semiconductor chips.

FIG. 8 provides a schematic representation of an architecture of the kiosk 100 in accordance with an embodiment of the present technology. In the illustrated embodiment, the kiosk 100 includes a suitable processor or central processing unit (“CPU”) 800 that controls operation of the kiosk 100 in accordance with computer-readable instructions stored on system memory 806. The CPU 800, for example, can control performance of the various dynamic pricing routines described herein with reference to, for example, FIGS. 3-7B. The CPU 800 may be any logic processing unit, such as one or more CPUs, digital signal processors (DSPs), application-specific integrated circuits (ASICs), etc. The CPU 800 may be a single processing unit or multiple processing units in a device or distributed across multiple devices. The CPU 800 is connected to the memory 806 and may be coupled to other hardware devices, for example, with the use of a bus (e.g., a PCI Express or Serial ATA bus). The CPU 800 can include, by way of example, a standard personal computer (“PC”) (e.g., a DELL OPTIPLEX 780 or 7010 PC) or other type of embedded computer running any suitable operating system, such as Linux, Windows, Android, iOS, MAC OS, or an embedded real-time operating system. In some embodiments, the CPU 800 can be a small form factor PC with integrated hard disk drive (“HDD”) or solid-state drive (“SSD”) and universal serial bus (“USB”) or other ports to communicate with the other components of the kiosk 100. In other embodiments, the CPU 800 can include a microprocessor with a standalone motherboard that interfaces with a separate HDD. The memory 806 can include read-only memory (ROM) and random access memory (RAM) or other storage devices, such as disk drives or SSDs, that store the executable applications, test software, databases and other software required to, for example, implement the various routines described herein (e.g., those described with reference to FIGS. 3, 4, and 6), control kiosk components, process electronic device information and data (to, e.g., evaluate device make, model, condition, pricing, etc.), communicate and exchange data and information with remote computers and other devices, etc.

The CPU 800 can provide information and instructions to kiosk users via the display screen 104 and/or an audio system (e.g., a speaker) 804. The CPU 800 can also receive user inputs via, e.g., a touch screen 808 associated with the display screen 104, a keypad with physical keys, and/or a microphone 810. Additionally, the CPU 800 can receive personal identification and/or biometric information associated with users via the ID reader 112, one or more of the external cameras 116, and/or the fingerprint reader 114. In some embodiments, the CPU 800 can also receive information (such as user identification and/or account information) via a card reader 812 (e.g., a debit, credit, or loyalty card reader having, e.g., a suitable magnetic stripe reader, optical reader, etc.). The CPU 800 can also control operation of the label dispenser 110 and systems for providing remuneration to users, such as the cash dispenser 118 and/or a receipt or voucher printer and an associated dispenser 820.

As noted above, the kiosk 100 additionally includes a number of electronic, optical and electromechanical devices for electrically, visually and/or physically analyzing electronic devices placed therein for recycling. Such systems can include one more internal cameras 814 for visually inspecting electronic devices to, e.g., determine the external dimensions and condition, and one or more of the electrical connectors 242 (e.g., USB connectors) for, e.g., powering up electronic devices and performing electronic analyses. As noted above, the cameras 814 can be operably coupled to the upper and lower chambers 230 and 232, and the connectors 242 can be movably and interchangeably carried by the carrousel 240 (FIGS. 2A-2D). The kiosk 100 further includes a plurality of mechanical components that are electronically actuated for carrying out the various functions of the kiosk 100 during operation. The mechanical components 818 can include, for example, the inspection area access door 106 and one or more of the movable components (e.g. the inspection plate 244, the upper and lower chambers 230 and 232, etc.) operably disposed within the inspection area 108 (FIG. 1). The kiosk 100 further includes power 802, which can include battery power and/or facility power for operation of the various electrical components associated with kiosk operation.

In the illustrated embodiment, the kiosk 100 further includes a network connection 822 (e.g., a wired connection, such as an Ethernet port, cable modem, FireWire cable, Lightning connector, USB port, etc.) suitable for communication with, e.g., all manner of remote processing devices via a communication link 850, and a wireless transceiver 824 (e.g., including a Wi-Fi access point, Bluetooth transceiver, near-field communication (NFC) device, and/or wireless modem or cellular radio utilizing GSM, CDMA, 3G and/or 4G technologies) for data communications suitable for communication with, e.g., all manner of remote processing devices via the communication link 850 and/or directly via, e.g., a wireless peer-to-peer connection. For example, the wireless transceiver 824 can facilitate wireless communication with handheld devices, such as a mobile device 830 (e.g., a smartphone) either in the proximity of the kiosk 100 or remote therefrom. By way of example only, in the illustrated embodiment the mobile device 830 can include one or more features, applications and/or other elements commonly found in smartphones and other known mobile devices. For example, the mobile device 830 can include a CPU and/or a graphics processing unit (“GPU”) 834 for executing computer readable instructions stored on memory 836. In addition, the mobile device 830 can include an internal power source or battery 832, a dock connector 846, a USB port 348, a camera 840, and/or well-known input devices, including, for example, a touch screen 842, a keypad, etc. In many embodiments, the mobile device 830 can also include a speaker 844 for two-way communication and audio playback. In addition to the foregoing features, the mobile device 830 can include a mobile operating system (OS) 831 and/or a device wireless transceiver that may include one or more antennas 338 for wirelessly communicating with, for example, other mobile devices, websites, and the kiosk 100. Such communication can be performed via, e.g., the communication link 850 (which can include the Internet, public and private intranet, a local or extended Wi-Fi network, cell towers, the plain old telephone system (POTS), etc.), direct wireless communication, etc.

Unless described otherwise, the construction and operation of the various components shown in FIG. 8 are of conventional design. As a result, such components need not be described in further detail herein, as they will be readily understood by those skilled in the relevant art. In other embodiments, the kiosk 100 and/or the mobile device 830 can include other features that may be different from those described above. In still further embodiments, the kiosk 100 and/or the mobile device 830 can include more or fewer features similar to those described above.

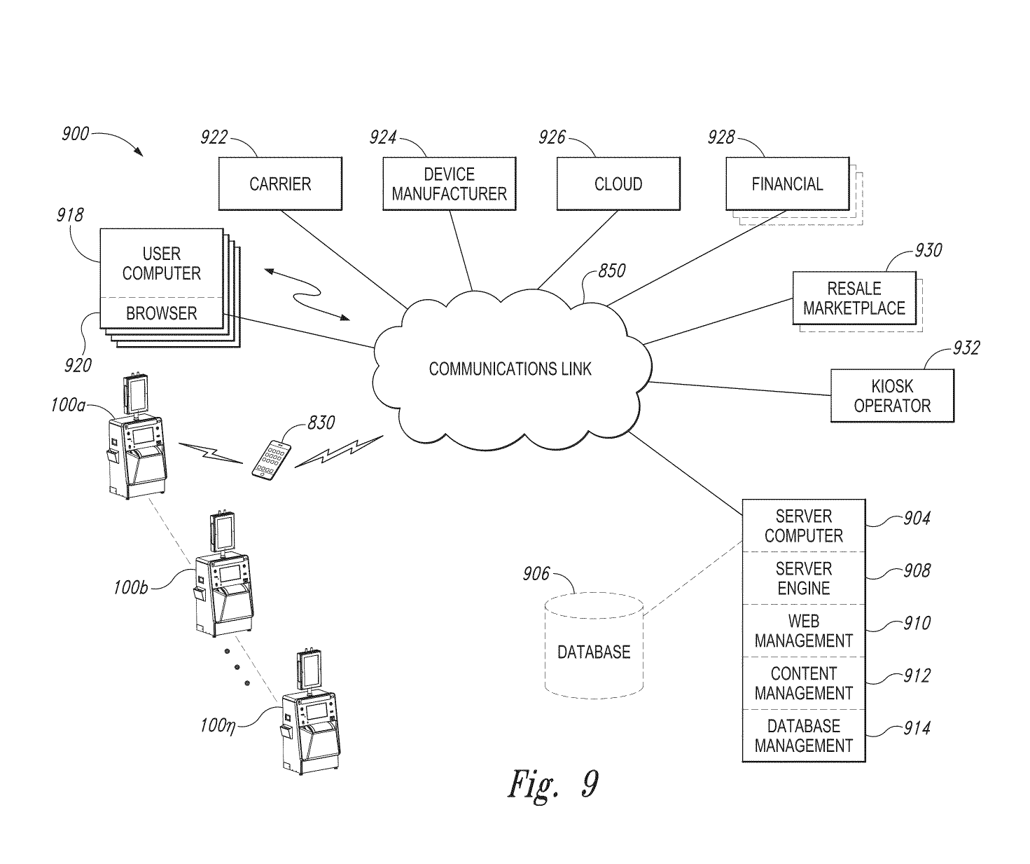

FIG. 9 is a schematic diagram of a suitable network environment for implementing various aspects of an electronic device recycling system 900 configured in accordance with embodiments of the present technology. In the illustrated embodiment, a plurality of the kiosks 100 (identified individually as kiosks 100a-10On) can exchange information with one or more remote computers (e.g., one or more server computers 904) via the communication link 850. Although the communication link 850 can include a publically available network (e.g., the Internet with a web interface), a private communication link, such as an intranet or other network may also be used. Moreover, in various embodiments the individual kiosk 100 can be connected to a host computer (not shown) that facilitates the exchange of information between the kiosks 100 and remote computers, other kiosks, mobile devices, etc.

The server computer 904 can perform many or all of the functions for receiving, routing and storing electronic messages, such as webpages, audio signals and electronic images necessary to implement the various electronic transactions described herein. For example, the server computer 904 can retrieve and exchange web pages and other content with an associated database or databases 906. In some embodiments, the database 906 can include information related to mobile phones and/or other consumer electronic devices. Such information can include, for example, make, model, serial number, IMEI, MEID, carrier plan information, pricing information, owner information, etc., as well as dimensional information (size, shape, location of displays, ports, etc.) and other visual information (e.g., logo shapes, sizes, locations, etc.) associated with known devices, such as particular device models, sub-models, etc. In various embodiments the server computer 904 can also include a server engine 908, a web page management component 910, a content management component 912, and a database management component 914. The server engine 908 can perform the basic processing and operating system level tasks associated with the various technologies described herein. The webpage management component 910 can handle creation and/or display and/or routing of web or other display pages. The content management component 912 can handle many of the functions associated with the routines described herein. The database management component 914 can perform various storage, retrieval and query tasks associated with the database 906, and can store various information and data such as animation, graphics, visual and audio signals, etc. Those of ordinary skill in the art will appreciate that many of the routines and/or portions thereof and other functions and methods described above can be performed by the kiosk 100 (e.g., the processor 800), the server computer 904, or both.

In the illustrated embodiment, the kiosks 100 can also be operably connected to a plurality of other remote devices and systems via the communication link 850. For example, the kiosks 100 can be operably connected to a plurality of user devices 918 (e.g., personal computers, laptops, handheld devices, etc.) having associated browsers 920. Similarly, as described above the kiosks 100 can each include wireless communication facilities for exchanging digital information with mobile devices, such as the mobile device 830. The kiosks 100 and/or the server computer 904 are also operably connectable to a series of remote computers for obtaining data and/or exchanging information with necessary service providers, financial institutions, device manufactures, authorities, government agencies, etc. For example, the kiosks 100 and the server computer 904 can be operably connected to one or more cell carriers 922, one or more device manufacturers 924 (e.g., mobile phone manufacturers), one or more electronic payment or financial institutions 928, one or more databases (e.g., the GSMA International Mobile Equipment Identity Database, etc.), and one or more computers and/or other remotely located or shared resources associated with cloud computing 926. The financial institutions 928 can include all manner of entity associated with conducting financial transactions, including banks, credit/debit card facilities, online commerce facilities, online payment systems, virtual cash systems, money transfer systems, etc.

In addition to the foregoing, the kiosks 100 and the server computer 904 can also be operably connected to a resale marketplace 930 and a kiosk operator 932. The resale marketplace 930 represents a system of remote computers and/or services providers associated with the reselling of consumer electronic devices through both electronic and brick-and-mortar channels. Such entities and facilities can be associated with, for example, online auctions for reselling used electronic devices as well as for establishing market prices for such devices. The kiosk operator 932 can be a central computer or system of computers for controlling all manner of operation of the network of kiosks 100. Such operations can include, for example, remote monitoring and facilitating of kiosk maintenance (e.g., remote testing of kiosk functionality, downloading operational software and updates, etc.), servicing (e.g., periodic replenishing of cash and other consumables), performance, etc. In addition, the kiosk operator 932 can further include one or more display screens operably connected to cameras located at each of the kiosks 100 (e.g., one or more of the cameras 116 described above with reference to FIG. 1). This remote viewing capability enables operator personnel to verify user identification and/or make other visual observations at the kiosks 100 in real-time during transactions, as described above with reference to FIG. 1.

The foregoing description of the electronic device recycling system 900 illustrates but one possible network system suitable for implementing the various technologies described herein. Accordingly, those of ordinary skill in the art will appreciate that other systems consistent with the present technology can omit one or more of the facilities described in reference to FIG. 9 or may include one or more additional facilities not described in detail in FIG. 9.

Those of ordinary skill in the art will appreciate that the routines and other functions and methods described above can be performed by various processing devices, such as the kiosk processor 800 (FIG. 8), the server computer 904 (FIG. 9), or both. The processes can be implemented as an application specific integrated circuit (ASIC), by a digital signal processing (DSP) integrated circuit, through conventional programmed logic arrays or circuit elements. While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

The kiosks 100, mobile devices 330, server computers 904, user computers and/or other user devices 918, etc. may include one or more central processing units or other logic-processing circuitry, memory, input devices (e.g., keyboards and pointing devices), output devices (e.g., display devices and printers), and storage devices (e.g., magnetic, solid state, fixed and floppy disk drives, optical disk drives, etc.). Such computer devices may include other program modules such as an operating system, one or more application programs (e.g., word processing or spread sheet applications), and the like. The user computers may include wireless computers, such as mobile phones, personal digital assistants (PDAs), palm-top computers, etc., which communicate with the Internet via a wireless link. The computers may be general-purpose devices that can be programmed to run various types of applications, or they may be single-purpose devices optimized or limited to a particular function or class of functions. Aspects of the invention may be practiced in a variety of other computing environments.

While the Internet is shown, a private network, such as an intranet may likewise be used herein. The network may have a client-server architecture, in which a computer is dedicated to serving other client computers, or it may have other architectures such as peer-to-peer, in which one or more computers serve simultaneously as servers and clients. A database or databases, coupled to the server computer(s), stores much of the web pages and content exchanged between the user computers. The server computer(s), including the database(s), may employ security measures to inhibit malicious attacks on the system and preserve the integrity of the messages and data stored therein (e.g., firewall systems, message encryption and/or authentication (e.g., using transport layer security (TLS) or secure socket layers (SSL)), password protection schemes, encryption of stored data (e.g., using trusted computing hardware), and the like).

One skilled in the relevant art will appreciate that the concepts of the invention can be used in various environments other than location based or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can be implemented in or for any e-mail environment.

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein, and refer to any of the above devices and systems, as well as any data processor. Input devices may include a touchpad, keyboard and/or a pointing device such as a mouse. Other input devices are possible such as a microphone, joystick, pen, game pad, scanner, digital camera, video camera, and the like. The data storage devices may include any type of computer-readable media that can store data accessible by a computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. The data storage devices may include any type of computer-readable media that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a propagating signal per se.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like, are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples—alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims. Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method performed by a computing device for recycling electronic devices, the method comprising:
setting a first price for a type of electronic device;
receiving a first plurality of the type of electronic devices from a first plurality of users at one or more kiosks;
offering each of the first plurality of users the first price for the type of electronic device;
automatically determining a first percentage of the first plurality of users who accept the first price for the type of device;
based on the determined first percentage, automatically determining a second price for the type of electronic device, wherein the second price is different than the first price;
receiving a second plurality of the type of electronic devices from a second plurality of users at the one or more kiosks; and
offering each of the second plurality of users the second price for the type of electronic device.

2. The method of claim 1, further comprising:
automatically determining a second percentage of the second plurality of users who accept the second price for the type of device;
automatically determining a first total margin for a first plurality of transactions comprising the first plurality of users who accept the first price; and
automatically determining a second total margin for a second plurality of transactions comprising the second plurality of users who accept the second price.

3. The method of claim 2 wherein the first total margin is the number of offers accepted for the type of electronic device multiplied by a margin for each electronic device of the type, and wherein the second total margin is the number of offers accepted for the type of electronic device multiplied by the margin for each electronic device of the type.

4. The method of claim 3, further comprising:
when the second price is higher than the first price, and when the second total margin is greater than the first total margin:
automatically determining a third price, the third price higher than the second price;
receiving a third plurality of the type of electronic device from a third plurality of users at the one or more kiosks; and
offering each of the third plurality of users the third price for the type of electronic device.

5. The method of claim 3, further comprising:
when the second price is higher than the first price, and when the second total margin is less than the first total margin:
automatically determining a third price, the third price lower than the second price;
receiving a third plurality of the type of electronic device from a third plurality of users at the one or more kiosks; and
offering each of the third plurality of users the third price for the type of electronic device.

6. The method of claim 3, further comprising:
when the second price is lower than the first price, and when the second total margin is greater than the first total margin, the method further comprises:
automatically determining a third price, the third price lower than the second price;
receiving a third plurality of the type of electronic device from a third plurality of users at the one or more kiosks; and
offering each of the third plurality of users the third price for the type of electronic device.

7. The method of claim 3, further comprising:
when the second price is lower than the first price, and when the second total margin is less than the first total margin:
automatically determining a third price, the third price higher than the second price;
receiving a third plurality of the type of electronic device from a third plurality of users at the one or more kiosks; and
offering each of the third plurality of users the third price for the type of electronic device.

8. The method of claim 1 wherein the type of electronic device comprises a make, a model, and a condition range of an electronic device.

9. The method of claim 1 wherein the first plurality of users and the second plurality of users each comprises at least 30 individuals.

10. The method of claim 1 wherein the type of electronic device comprises a smartphone.

11. A method performed by a computing device for recycling electronic devices, the method comprising:
setting a plurality of different prices for a type of electronic device;
receiving a plurality of the type of electronic device from a plurality of users at a plurality of kiosks;
offering each of the users one of the plurality of prices for the type of electronic device;
for each of the plurality of prices offered to the users, automatically determining a corresponding percentage of the plurality of users who accept each price for the type of electronic device; and
based on the corresponding percentages, automatically selecting one of the plurality of prices and offering the selected price for the type of electronic device at the plurality of kiosks.

12. The method of claim 11 wherein the plurality of prices comprises at least five different prices.

13. The method of claim 11 wherein the type of electronic device comprises a make, a model, and a condition range of an electronic device.

14. The method of claim 11 wherein the plurality of users comprises at least 30 individuals.

15. The method of claim 11, further comprising automatically determining a total margin for each of the plurality of prices, wherein the total margin is the number of offers accepted for the type of electronic device at each price multiplied by a margin for each electronic device of the type at that price.

16. The method of claim 15, further comprising comparing the total margins for each of the plurality of prices wherein automatically selecting one of the plurality of prices includes automatically selecting one of the plurality of prices based on the comparison.

17. A computer readable storage medium storing instructions configured to, when executed by a computing device, cause the computing device to perform operations associated with purchasing electronic devices from users, the operations comprising:
setting a first price for a type of electronic device;
evaluating a first plurality of the type of electronic device owned by a first plurality of users;
offering each of the first plurality of users the first price for the type of electronic device;
automatically determining a first percentage of the first plurality of users who accept the first price;
based on the determined first percentage, automatically determining a second price for the type of electronic device, wherein the second price is different than the first price;
evaluating a second plurality of the type of electronic device owned by a second plurality of users; and
offering each of the second plurality of users the second price for the type of electronic device.

18. The computer readable storage medium of claim 17 wherein evaluating the first plurality of the type of electronic device comprises receiving the first plurality of the type of electronic device at a kiosk and evaluating the first plurality via the kiosk.

19. The computer readable storage medium of claim 17 wherein evaluating the first plurality of the type of electronic device comprises remotely evaluating the first plurality via an application on an electronic device.

20. The computer readable storage medium of claim 17 wherein the operations further comprise:
automatically determining a second percentage of the second plurality of users who accept the second price;
automatically determining a first total margin for a first plurality of transactions comprising the first plurality of users who accept the first price; and
automatically determining a second total margin for a second plurality of transactions comprising the second plurality of users who accept the second price.

21. The computer readable storage medium of claim 20 wherein the first total margin is the number of offers accepted for the type of electronic device multiplied by a margin for each electronic device of the type purchased at the first price, and wherein the second total margin is the number of offers accepted for the type of electronic device multiplied by a margin for each electronic device of the type purchased at the second price.

22. A computer readable storage medium storing instructions configured to, when executed by a computing device, cause the computing device to perform operations for purchasing electronic devices from users, the operations comprising:
setting a plurality of different prices for a type of electronic device;
receiving a plurality of the type of electronic devices from a plurality of users at a plurality of kiosks;
offering each of the users one of the plurality of prices for the type of electronic device;
for each of the plurality of prices offered to users, automatically determining a corresponding percentage of the plurality of users who accept each price for the type of electronic device; and
based on the corresponding percentages, automatically selecting one of the plurality of prices and offering the selected price for the type of electronic device at the plurality of kiosks.

23. The computer readable medium of claim 22 wherein the plurality of prices comprises at least five different prices.

24. The computer readable medium of claim 22 wherein the plurality of users comprises at least 30 individuals.

25. The computer readable medium of claim 22 wherein the operations further comprise automatically determining a total margin for each of the plurality of prices, wherein the total margin is the number of offers accepted for the type of electronic device at each price multiplied by a margin for each electronic device of the first type at that price.

26. A system for purchasing electronic devices from consumers, the system comprising:
an inspection area for receiving electronic devices;
an imaging component operably disposed in relation to the inspection area to visually inspect electronic devices received therein;
a processing device operably connected to the imaging component; and
a computer-readable medium that contains computer-executable instructions configured to cause the processing device to operate the system according to a method that comprises:
receiving a first plurality of a type of electronic device from a plurality of users in the inspection area;
offering each of the first plurality of users the first price for the type of electronic device;
automatically determining a first percentage of the first plurality of users who accept the first price for the type of device;
based on the determined first percentage, automatically determining a second price for the type of electronic device, wherein the second price is different than the first price;
receiving a second plurality of the type of electronic devices from a second plurality of users in the inspection area; and
offering each of the second plurality of users the second price for the type of electronic device.

27. The system of claim 26, further comprising an electrical connector operably connected to the processing device and configured to be temporarily connected to the electronic device, wherein the method further comprises obtaining electrical information about the electronic device via the electrical connector.

30. The system of claim 26 wherein the inspection area is configured to receive mobile phones, and wherein the system further comprises a consumer operated kiosk, wherein at least the inspection area and the imaging component are operably contained within the kiosk.

31. The system of claim 26 wherein the inspection area is configured to receive computing devices, and wherein the system further comprises a consumer operated kiosk, wherein at least the inspection area and the imaging component are operably contained within the kiosk.

32. The system of claim 26, further comprising a countertop-mounted machine, wherein at least the imaging component and the processing device are operably coupled to the countertop machine.

33. The system of claim 26, further comprising a means for verifying an identity of the user.
